(19) United States
(12) Patent Application Publication
(10) Pub. No.: US 2026/0355869 A1
(43) Pub. Date: Nov. 12, 2026

(54) WORKTABLE FOR LASER PROCESSING AND LASER PROCESSING APPARATUS

(71) Applicant: Samsung Display Co., LTD., Yongin-si (KR)

(72) Inventors: Hak Min KIM, Yongin-si (KR); Il Young JEONG, Yongin-si (KR); Kang Hyuk LEE, Yongin-si (KR); Jong Hee LIM, Yongin-si (KR); Sang Sun HAN, Yongin-si (KR)

(21) Appl. No.: 19/391,132

(22) Filed: Nov. 17, 2025

(30) Foreign Application Priority Data
May 8, 2025 (KR) 10-2025-0060007

(51) Int. Cl. B23K 37/04; B23K 26/142; B23K 26/70

(52) U.S. Cl. CPC B23K 37/04; B23K 26/142; B23K 26/702

(57) ABSTRACT

A worktable for laser processing includes a first base part in which a first base part hole and a groove are defined; a first plate disposed in the first base part hole; and a second plate disposed on the first base part. The groove overlaps with a cutting line of an object being laser processed along the cutting line, and the second plate is spaced apart from the groove.

### CROSS-REFERENCE TO RELATED APPLICATION

This application claims priority to Korean patent application 10-2025-0060007, filed on May 08, 2025, and all the benefits accruing therefrom under 35 U.S.C. §119, the content of which in its entirety is herein incorporated by reference.

### BACKGROUND

### 1. Technical Field

The present disclosure generally relates to a worktable for laser processing and a laser processing apparatus.

### 2. Related Art

In manufacturing a display device, such as an organic light-emitting display device, a liquid crystal display device, or the like, a processing process may be performed to cut an object into a predetermined shape. Such the processing process may be performed using a laser processing apparatus.

The processing process may be performed by placing an object on a worktable for laser processing and irradiating the object with a laser beam at a desired location. A laser unit for irradiating the laser beam onto the object may be located on a top of the worktable for laser processing. By irradiating the laser beam as the laser unit moves along a cutting line on the object, the object may be cut along the cutting line.

When the object is being cut, the laser may generate fumes. If the fumes are not removed, it may interfere with the laser and cause the object to not be cut properly. Therefore, it is necessary to remove the fumes in order for the object to be cut properly along the cutting line.

The above description is intended solely to provide an understanding of the background technology for the technical ideas of the present invention and is not to be construed as constituting prior art known to those skilled in the art of the present invention.

### SUMMARY

One aspect of the present disclosure is to provide a worktable for laser processing and a laser processing apparatus that may effectively remove fumes generated in a laser processing process.

One aspect of the present disclosure is to provide a worktable for laser processing and a laser processing apparatus that may reduce manufacturing costs.

One aspect of the present disclosure is to provide a worktable for laser processing and a laser processing apparatus that may improve laser processing process efficiency.

The aspects of the present invention are not limited to those mentioned above, and other technical aspects not mentioned will be apparent to those skilled in the art from the following description.

A worktable for laser processing, according to an embodiment of the present disclosure, includes a first base part in which a first base part hole and a groove are defined; a first plate disposed in the first base part hole; and a second plate disposed on the first base part, where the groove overlaps with a cutting line of an object being laser processed along the cutting line, and the second plate is spaced apart from the groove.

According to an embodiment, the second plate may not overlap the groove in a plan view, and the second plate may not overlap the first plate in the plan view.

According to an embodiment, the second plate may enclose at least a portion of the first plate in the plan view.

According to an embodiment, the second plate may be adjacent to the groove.

According to an embodiment, the second plate may include: a second-first plate portion spaced apart from the first base part; and a second-second plate portion connected to the second-first plate portion, and in contact with the first base part, and a first empty space may be defined between the second-first plate portion and the first base part.

According to an embodiment, a discharge channel passing through the first base part may be defined in the first base part, and the first empty space and the discharge channel may be fluidly connected.

According to an embodiment, the worktable for laser processing may further include a suction unit, and the suction unit and the discharge channel may be fluidly connected.

According to an embodiment, the suction unit may be configured to inhale fumes generated from the laser processing, and the groove and the suction unit may be fluidly connected.

According to an embodiment, the worktable for laser processing may further include a third plate disposed on the second plate.

According to an embodiment, a second-first plate hole passing through the second-first plate portion may be defined in the second plate.

According to an embodiment, the third plate may include: a third-first plate portion spaced apart from the second-first plate portion; and a third-second plate portion in contact with the second-second plate portion, and a second empty space may be defined between the third-first plate portion and the second-first plate portion.

A worktable for laser processing, according to an embodiment of the present disclosure, includes: a first base part in which a first base part hole and a discharge channel are defined; a first plate disposed in the first base part hole; and a second plate disposed on the first base part, the second plate includes: a second-first plate portion spaced apart from the first base part; and a second-second plate portion connected to the second-first plate portion, and in contact with the first base part, a first empty space is defined between the second-first plate portion and the first base part, and the first empty space and the discharge channel are fluidly connected.

According to an embodiment, a groove passing through the first base part may be defined in the first base part, the groove may overlap a cutting line of an object being laser processed along the cutting line, and the second plate may not overlap the groove in a plan view.

According to an embodiment, the second plate may not overlap the first plate in the plan view, the groove may enclose at least a portion of the first plate in the plan view, and the second plate may be adjacent to the groove.

According to an embodiment, the second plate may enclose at least a portion of the first plate in the plan view

According to an embodiment, the worktable for laser processing may further include: a suction unit configured to inhale fumes generated from the laser processing, and the suction unit may be fluidly connected with each of the groove and the discharge channel.

According to an embodiment, the worktable for laser processing may further include: a third plate disposed on the second plate, the third plate may include: a third-first plate portion spaced apart from

the second-first plate portion; and a third-second plate portion in contact with the second-second plate portion, and a second empty space may be defined between the third-first plate portion and the second-first plate portion.

A laser processing apparatus for laser processing an object, according to an embodiment of the present disclosure, includes: a first base part in which a first base part hole and a groove are defined; a first plate disposed in the first base part hole; and a second plate disposed on the first base part, the groove overlaps with a cutting line along which the laser processing apparatus cuts the object, and the second plate is spaced apart from the groove.

According to an embodiment, the second plate may enclose at least a portion of the first plate in a plan view, the second plate may include: a second-first plate portion spaced apart from the first base part; and a second-second plate portion connected to the second-first plate portion, and in contact with the first base part, and an empty space may be defined between the second-first plate portion and the first base part. According to an embodiment, the laser processing apparatus may further include a suction unit configured to inhale fumes generated from the laser processing, a discharge channel passing through the first base part may be defined in the first base part, the fumes may be sucked into the suction unit along each of a first path and a second path, the first path may pass through the groove, and the second path may pass through the empty space and the discharge channel.

### BRIEF DESCRIPTION OF THE DRAWINGS

FIG. 1 is a perspective view schematically illustrating a laser processing apparatus according to an embodiment.

FIG. 2 is a plan view schematically illustrating a laser processing apparatus according to an embodiment.

FIG. 3 is a schematic cross-sectional perspective view taken along line A-A’ of FIG. 2.

FIG. 4 is a schematic cross-sectional view of a laser processing apparatus to illustrate flow path of fumes.

FIG. 5 is a perspective view schematically illustrating a laser processing apparatus according to another embodiment.

FIG. 6 is a schematic cross-sectional perspective view taken along line B-B’ of FIG. 5.

### DETAILED DESCRIPTION

The present disclosure may apply various changes and different shape, therefore only illustrate in detail with particular examples. However, the examples do not limit to certain shapes but apply to all the change and equivalent material and replacement. The drawings included are illustrated as a fashion where the figures are expanded for the better understanding.

It will be understood that, although the terms "first", "second", “second-first”, “third-first”, “second-second”, “third-second”, etc. may be used herein to describe various elements, these elements should not be limited by these terms. These terms are only used to distinguish one element from another element. Thus, a "first" element discussed below could also be termed a "second" element without departing from the teachings of the present disclosure. As used herein, the singular forms are intended to include the plural forms as well, unless the context clearly indicates otherwise.

It will be further understood that the terms "includes" and/or "including", when used in this specification, specify the presence of stated features, integers, steps, operations, elements, and/or components, but do not preclude the presence and/or addition of one or more other features, integers, steps, operations, elements, components, and/or groups thereof. Further, an expression that an element such as a layer, region, substrate or plate is placed "on" or "above" another element indicates not only a case where the element is placed "directly on" or "just above" the other element but also a case where a further element is interposed between the element and the other element. On the contrary, an expression that an element such as a layer, region, substrate or plate is placed "beneath" or "below" another element indicates not only a case where the element is placed "directly beneath" or "just below" the other element but also a case where a further element is interposed between the element and the other element.

The present disclosure relates to a worktable for laser processing and a laser processing apparatus. Hereinafter, a worktable for laser processing and a laser processing apparatus according to embodiments will be described with reference to the accompanying drawings.

In the following drawings, a first direction DR1 and a second direction DR2 are defined as a direction extending from a plane in which the laser processing apparatus 10 is disposed or a direction parallel to the plane in which a processing object of the laser processing apparatus 10 is disposed, and a third direction DR3 is defined as a direction perpendicular to the plane in which the laser processing apparatus 10 is disposed (or the plane in which the processing object is disposed).

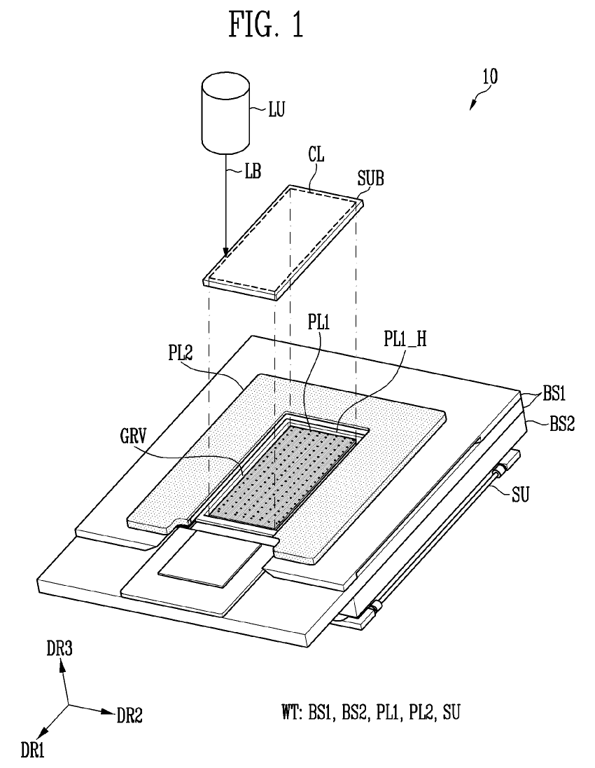

FIG. 1 is a perspective view schematically illustrating a laser processing apparatus according to an embodiment.

Referring to FIG. 1, a laser processing apparatus 10 may include a worktable for laser processing WT and a laser unit LU. The worktable for laser processing WT may include a first base part BS1, a second base part BS2, a first plate PL1, a second plate PL2, and a suction unit SU.

An object to be laser processed (e.g., a substrate SUB) may be mounted on an upper surface of the worktable for laser processing WT.

For example, the substrate SUB may be mounted on the upper surface of the first plate PL1. That is, the first plate PL1 may support the substrate SUB. According to an embodiment, the worktable for laser processing PT may be fixed. Alternatively, according to an embodiment, the worktable for laser processing WT may move or rotate in a predetermined direction.

The laser unit LU may be disposed on the worktable for laser processing WT. The laser unit LU may move on the worktable for laser processing WT, and may generate and irradiate a laser beam LB. For example, the laser beam LB may include a gaseous laser, such as a carbon dioxide laser, an excimer laser, a helium-neon laser, or the like. Alternatively, according to an embodiment, the laser beam LB may include a solid-state laser, such as a ruby laser, a glass laser, a YAG laser, a YLF laser, or the like. The object to be processed by the laser processing apparatus 10 (e.g., the substrate SUB) may have various sizes. The substrate SUB may include a cutting line CL. The laser unit LU may irradiate the laser beam LB along the cutting line CL on the substrate SUB. That is, the substrate SUB may be processed and cut along the cutting line CL.

The first base part BS1 and the second base part BS2 may form an outline of the worktable for laser processing WT. For example, the first base part BS1 may correspond to a top plate of the worktable for laser processing WT. The second base part BS2 may correspond to a bottom plate of the worktable for laser processing WT. The first base part BS1 and the second base part BS2 may be coupled so as to be assembled. For example, the first base part BS1 may be disposed on the second base part BS2 and may be assembled with the second base part BS2. However, the present disclosure is not limited thereto. According to an embodiment, the first base part BS1 and the second base part BS2 may be integrally formed.

In the first base part BS1, a first base part hole PL1_H and a groove GRV that penetrate the first base part BS1 may be defined. Each of the first base part hole PL1_H and the groove GRV may completely penetrate the first base part BS1.

The first base part hole PL1_H may accommodate the first plate PL1. For example, the first base part hole PL1_H may provide a space in which the first plate PL1 is disposed. For example, the first plate PL1 may be disposed inside the first base part hole PL1_H. For example, in a plan view, the region in which the first base part hole PL1_H is defined and the region in which the first plate PL1 is disposed may overlap. As used herein, the “plan view” is a view in a thickness direction (e.g., third direction DR3) of the worktable.

The first base part hole PL1_H may have a shape corresponding to the first plate PL1. For example, if the first plate PL1 has a shape of a square in a plan view, the first base part hole PL1_H may have a shape of a square in a plan view. However, the present disclosure is not limited to this, and according to an embodiment, the first plate PL1 may have various shapes, and the first base part hole PL1_H may have various shapes corresponding to the shape of the first plate PL1.

The groove GRV may be formed along the cutting line CL of the substrate SUB to prevent damage to the worktable for laser processing WT and the substrate SUB by the laser beam LB. For example, the groove GRV may overlap the cutting line CL in a plan view. Accordingly, the laser beam LB may pass through the cutting line CL of the substrate SUB and irradiate into the groove GRV.

The groove GRV may be located adjacent to the first base part hole PL1_H. For example, the groove GRV may enclose the first base part hole PL1_H. For example, in a plan view, the groove GRV may enclose the first plate PL1.

The second plate PL2 may be disposed adjacent to the groove GRV. For example, in a plan view, the second plate PL2 may be spaced apart from the groove GRV by a distance and may enclose at least a portion of the groove GRV. For example, in a plan view, the second plate PL2 may not overlap the groove GRV, and the second plate PL2 may enclose at least a portion of the groove GRV. For example, in a plan view, the second plate PL2 may be spaced apart from the groove GRV, and the second plate PL2 may enclose at least a portion of the groove GRV.

The suction unit SU may be configured to inhale foreign substance (e.g., fumes, etc.) generated by the laser processing process. According to an embodiment, the suction unit SU may include a suction duct for inhaling the foreign substance generated by the laser processing, a blower for generating an air flow, and an exhaust duct for exhausting the inhaled foreign substance.

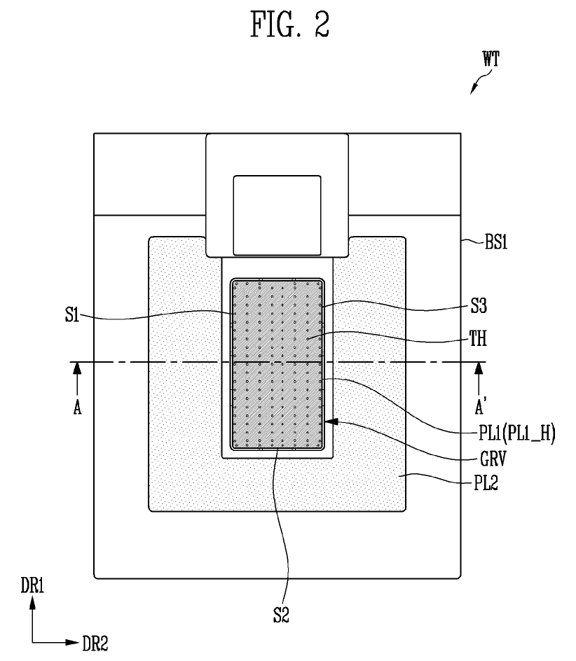

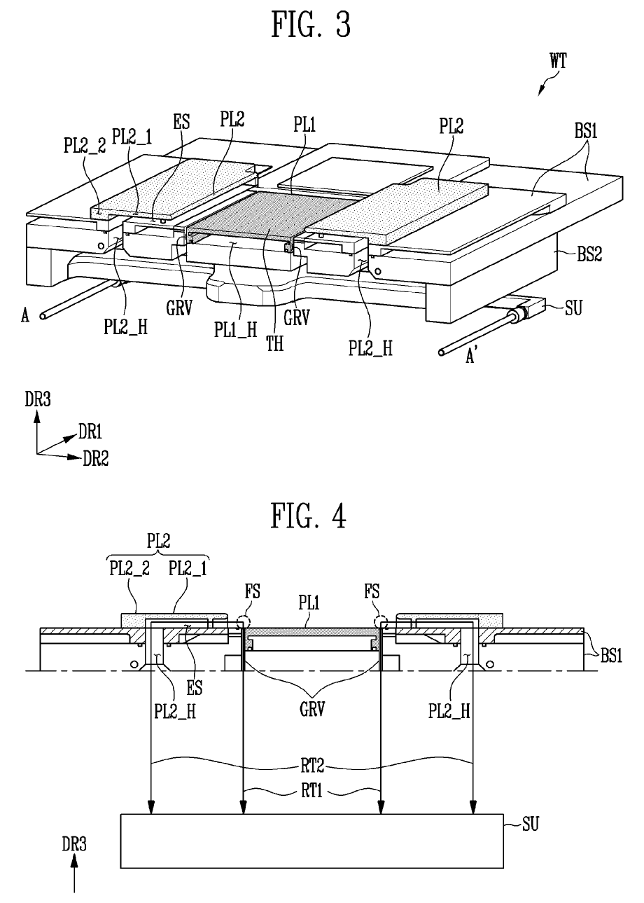

FIG. 2 is a plan view schematically illustrating a laser processing apparatus according to an embodiment. FIG. 3 is a schematic cross-sectional perspective view illustrating schematically taken along line A-A’ of FIG. 2. FIG. 4 is a schematic cross-sectional view of a laser processing apparatus for illustrating a flow path of fumes. In FIG. 4, for simplicity, the second base part BS2 is omitted.

Referring to FIG. 2, according to an embodiment, suction holes TH may be defined in the first plate PL1. The suction holes TH may penetrate the first plate PL1. The suction holes TH may be spaced apart from each other. For example, the suction holes TH may be arranged along the first direction DR1 and the second direction DR2.

The suction holes TH may suck a substrate SUB that is mounted on the top surface of the first plate PL1. For example, according to an embodiment, the laser processing apparatus 10 may further include a vacuum pressure device fluidly connected with the suction holes TH, and the vacuum pressure device may provide a vacuum pressure to the suction holes TH, thereby providing a suction force to the suction holes TH.

As used herein, "a first configuration and a second configuration are fluidly connected" may mean "the spaces are connected such that a fluid (e.g., gas, etc.) may move between the first configuration and the second configuration." For example, "the first configuration and the second configuration are fluidly connected" may mean "a fluid may flow uninterruptedly between the first configuration and the second configuration."

The first plate PL1 may include a first surface S1 extending along the first direction DR1, a second surface S2 connected to the first surface S1 and extending along the second direction DR2, and a third surface S3 connected to the second surface S2 and facing the first surface S1.

The second plate PL2 may not overlap the first plate PL1 in a plan view. The second plate PL2 may enclose at least a portion of the first plate PL1 in a plan view. For example, in a plan view, the second plate PL2 may enclose the first surface S1, the second surface S2, and the third surface S3 of the first plate PL1. For example, in a plan view, the second plate PL2 may be adjacent to the first surface S1, the second surface S2, and the third surface S3 of the first plate PL1.

Referring to FIG. 3, the second plate PL2 may be disposed higher than the first plate PL1. For example, the second plate PL2 may be disposed higher than the first plate PL1 in the third direction DR3.

The second plate PL2 may include a second-first plate portion PL2_1 and a second-second plate portion PL2_2. The second-first plate portion PL2_1 and the second-second plate portion PL2_2 may be connected to each other. For example, the second-first plate portion PL2_1 and the second-second plate portion PL2_2 may be formed integrally.

The second-first plate portion PL2_1 may be a portion of the second plate PL2 disposed spaced apart from the first base part BS1. For example, the second-first plate portion PL2_1 may be spaced apart from the upper surface of the first base part BS1 without contacting with the upper surface of the first base part BS1. The second-first plate portion PL2_1 may be disposed higher than the upper surface of the first base part BS1. For example, the second-first plate portion PL2_1 may be disposed higher than the surface on which the substrate SUB is disposed (e.g., the upper surface of the first base part BS1) in the third direction DR3.

The second-first plate portion PL2_1 may be spaced apart from the first base part BS1 to define an empty space ES. For example, the empty space ES may be formed between the second-first plate portion PL2_1 and the first base part BS1.

The second-second plate portion PL2_2 may be a portion of the second plate PL2 that is in contact with the first base part BS1. For example, the second-second plate portion PL2_2 may be connected to the second-first plate portion PL2_1 and extend in the opposite direction of the third direction DR3, and may be in contact with the first base part BS1. The second plate portion PL2_2 may be removably coupled to the first base part BS1. Accordingly, the second plate PL2 may be detachable from the worktable for laser processing WT. However, the present disclosure is not limited thereto, and according to an embodiment, the second plate PL2 may be integrally formed with the worktable for laser processing WT.

The first base part BS1 may further define a discharge channel PL2_H. The discharge channel PL2_H may penetrate the first base part BS1. The discharge channel PL2_H may be disposed adjacent to the second plate portion PL2_2, in a plan view. The discharge channel PL2_H may be disposed outward than the groove GRV in a plan view. For example, the discharge channel PL2_H may be disposed closer to an edge region of the worktable for laser processing WT than the groove GRV.

The discharge channel PL2_H may overlap the empty space ES in a plan view. The discharge channel PL2_H may be connected to the empty space ES. The discharge channel PL2_H may be fluidly connected to the empty space ES.

Referring to FIG. 4, when the substrate SUB is laser processed, fumes may be generated in the area FS that overlaps the groove GRV and is being laser processed. The suction unit SU may be fluidly connected with the groove GRV to inhale the fumes generated in the area FS where the laser processing is being performed. For example, the fumes generated in the area FS where laser processing is performed may be sucked into the suction unit SU along the first path RT1 passing through the groove GRV. For example, the fumes generated in the area FS where the laser processing is being performed may be sucked in along the opposite direction of the third direction DR3.

In FIG. 4, the second base part BS2 is shown omitted, but a first hole may be defined in the second base part BS2, overlapping the groove GRV in a plan view and penetrating the second base part BS2. The first hole passing through the second base part BS2 is fluidly connected with the groove GRV and may be fluidly connected with the suction unit SU.

The suction unit SU may be fluidly connected with the empty space ES and the discharge channel PL2_H. Fumes generated in the area FS where laser processing is being performed may be sucked into the suction unit SU along a second path RT2 passing through the empty space ES and the discharge channel PL2_H.

In FIG. 4, the second base part BS2 is omitted, but a second hole may be defined in the second base part BS2, overlapping the discharge channel PL2_H in a plan view and penetrating the second base part BS2. The second hole passing through the second base part BS2 is fluidly connected with the discharge channel PL2_H, and may be fluidly connected with the suction unit SU.

When the laser processing apparatus 10 includes the second plate PL2, the laser processing apparatus 10 according to the present disclosure may effectively remove the fumes flowing upward. For example, the second plate PL2 may be disposed close to the groove GRV with a distance of about 1 millimeter (mm) (0.1 mm to 10 mm, according to an embodiment), and the fumes generated in the area FS where laser processing is being performed may be appropriately sucked into the suction unit SU. For example, fumes generated in the area FS where laser processing is being performed and flowing upward may flow through the empty space ES along the bottom surface of the second-first plate portion PL2_1, and may be sucked into the suction unit SU through the discharge channel PL2_H. The worktable for laser processing WT according to the present disclosure may not only remove fumes through the groove GRV, but also remove fumes flowing upwardly through the second plate PL2.

Since the fumes generated in the area FS where laser processing is being performed and flowing upward is removed along the second path RT2, the laser unit LU of the laser processing apparatus 10 according to the present disclosure may not include a separate fumes suction part. If the laser unit LU includes a separate fumes suction part, it is necessary to install piping or the like to form the fumes suction part. According to the present disclosure, the laser unit LU of the laser processing apparatus 10 may not include a separate fumes suction part, so that manufacturing costs for installing piping or the like to form the fumes suction part may not be required. Accordingly, the manufacturing cost of the laser processing apparatus 10 may be reduced.

If the laser unit LU includes a separate fumes suction part, the fumes suction part of the laser unit LU needs to be modified when the size of the laser processing object changes. According to the present disclosure, the laser unit LU of the laser processing apparatus 10 does not include a separate fumes suction part, so that when the size of the laser processing object changes, the laser unit LU may not be modified. Accordingly, the laser unit LU may not be modified, and the cost and time for modifying the laser unit LU may be reduced, and the efficiency of the laser processing process may be increased.

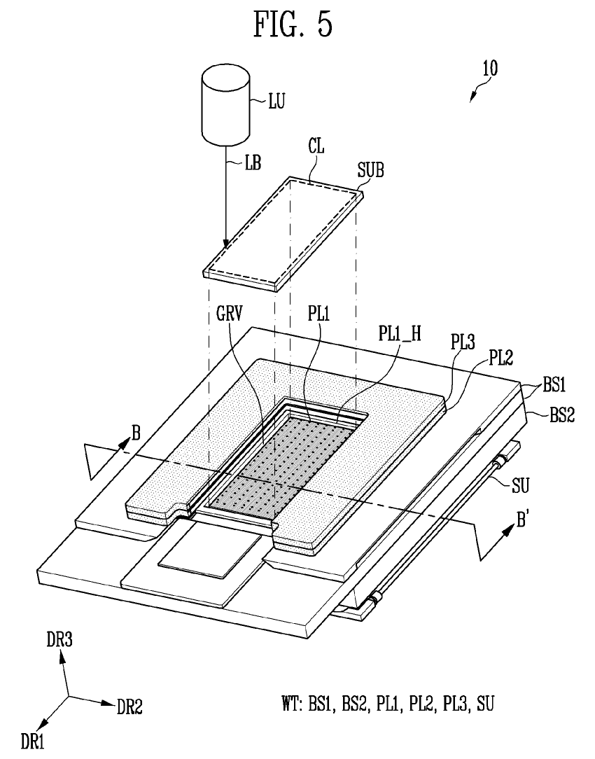

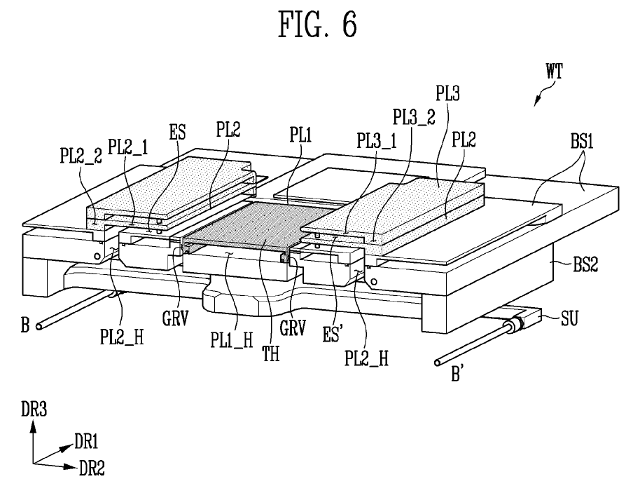

FIG. 5 is a schematic perspective view of a laser processing apparatus according to another embodiment. FIG. 6 is a schematic cross-sectional perspective view taken along line B-B’ of FIG. 5. The embodiment illustrated in FIGS. 5 and 6 differs from the foregoing embodiments in that it includes a third plate PL3.

Referring to FIGS. 5 and 6, the worktable for laser processing WT may further include a third plate PL3. The third plate PL3 may be disposed on the second plate PL2.

According to an embodiment, the third plate PL3 may have the same shape as the second plate PL2. However, the present disclosure is not limited thereto, and the third plate PL3 may have a different shape from the second plate PL2. According to an embodiment, when the third plate PL3 is further disposed, the height of the third plate PL3 may be varied, so that the pressure of the suction unit SU may be adjusted, and the flow rate of the fumes may be controlled.

The third plate PL3 may include a third-first plate portion PL3_1 and a third-second plate portion PL3_2. The third-first plate portion PL3_1 and the third-second plate portion PL3_2 may be connected to each other. For example, the third-first plate portion PL3_1 and the third-second plate portion PL3_2 may be formed integrally.

The third-first plate portion PL3_1 may not contact with the upper surface of the second-first plate portion PL2_1, and may be spaced apart from the upper surface of the second-first plate portion PL2_1. The third-first plate portion PL3_1 may be spaced apart from the second-first plate portion PL2_1 to define an empty space ES'. For example, an empty space ES' may be formed between the third-first plate portion PL3_1 and the second-first plate portion PL2_1.

According to an embodiment, a second-first plate hole may be defined in the second-first plate portion PL2_1, which is fluidly connected with the empty space ES'. The second-first plate hole is fluidly connected with the empty space ES', ES and may be fluidly connected with the discharge channel PL2_H.

The third-second plate portion PL3_2 may be in contact with the second-second plate portion PL2_2. For example, the third-second plate portion PL3_2 may be connected to the third-first plate portion PL3_1 and may extend in the opposite direction of the third direction DR3, and may be in contact with the second-second plate portion PL2_2. The third plate PL3 may be removably coupled to the second plate PL2. However, the present disclosure is not limited thereto, and in accordance with embodiments, the third plate PL3 may be integrally formed with the second plate PL2.

The fumes generated in the area FS where laser processing is being performed may flow through the empty spaces ES, ES' and may be sucked into the suction unit SU through the discharge channel PL2_H. The worktable for laser processing WT according to an embodiment may not only remove fumes through the groove GRV, but also remove fumes flowing upwardly through the second plate PL2 and the third plate PL3.

According to embodiments of the present disclosure, a worktable for laser processing and a laser processing apparatus capable of effectively removing fumes generated in a laser processing process may be provided.

According to embodiments of the present disclosure, a worktable for laser processing and a laser processing apparatus that can reduce manufacturing costs may be provided.

According to embodiments of the present disclosure, a worktable for laser processing and a laser processing apparatus capable of improving laser processing process efficiency may be provided.

While the foregoing has been described with reference to preferred embodiments of the disclosure, it will be appreciated by those skilled in the art or having ordinary knowledge of the art that various modifications and changes can be made to the disclosure without departing from the field of thought and technology described in the patent claims that will follow.

Accordingly, the technical scope of the present disclosure is not limited by the detailed description of the specification, but rather by the patent claims.

What is claimed is:

1. A worktable for laser processing comprising:
a first base part in which a first base part hole and a groove are defined;
a first plate disposed in the first base part hole; and
a second plate disposed on the first base part,
wherein the groove overlaps with a cutting line of an object being laser processed along the cutting line, and
wherein the second plate is spaced apart from the groove.

2. The worktable for laser processing of claim 1, wherein the second plate does not overlap the groove in a plan view, and
wherein the second plate does not overlap the first plate in the plan view.

3. The worktable for laser processing of claim 1, wherein the second plate encloses at least a portion of the first plate in a plan view.

4. The worktable for laser processing of claim 1, wherein the second plate is adjacent to the groove.

5. The worktable for laser processing of claim 1, wherein the second plate comprises:
a second-first plate portion spaced apart from the first base part; and
a second-second plate portion connected to the second-first plate portion, and in contact with the first base part, and
wherein a first empty space is defined between the second-first plate portion and the first base part.

6. The worktable for laser processing of claim 5, wherein a discharge channel passing through the first base part is defined in the first base part, and
wherein the first empty space and the discharge channel are fluidly connected.

7. The worktable for laser processing of claim 6, further comprising a suction unit,
wherein the suction unit and the discharge channel are fluidly connected.

8. The worktable for laser processing of claim 7, wherein the suction unit is configured to inhale fumes generated from the laser processing, and
wherein the groove and the suction unit are fluidly connected.

9. The worktable for laser processing of claim 5, further comprising a third plate disposed on the second plate.

10. The worktable for laser processing of claim 9, wherein a second-first plate hole passing through the second-first plate portion is defined in the second plate.

11. The worktable for laser processing of claim 9, wherein the third plate comprises:
a third-first plate portion spaced apart from the second-first plate portion; and
a third-second plate portion in contact with the second-second plate portion, and
wherein a second empty space is defined between the third-first plate portion and the second-first plate portion.

12. A worktable for laser processing comprising:
a first base part in which a first base part hole and a discharge channel are defined;
a first plate disposed in the first base part hole; and
a second plate disposed on the first base part,
wherein the second plate comprises:
a second-first plate portion spaced apart from the first base part; and
a second-second plate portion connected to the second-first plate portion, and in contact with the first base part,
wherein a first empty space is defined between the second-first plate portion and the first base part, and
wherein the first empty space and the discharge channel are fluidly connected.

13. The worktable for laser processing of claim 12, wherein a groove passing through the first base part is defined in the first base part,
wherein the groove overlaps a cutting line of an object being laser processed along the cutting line, and
wherein the second plate does not overlap the groove in a plan view.

14. The worktable for laser processing of claim 13, wherein the second plate does not overlap the first plate in the plan view,
wherein the groove encloses at least a portion of the first plate in the plan view, and
wherein the second plate is adjacent to the groove.

15. The worktable for laser processing of claim 13, wherein the second plate encloses at least a portion of the first plate in the plan view.

16. The worktable for laser processing of claim 13, further comprising:
a suction unit, which inhales fumes generated from the laser processing,
wherein the suction unit is fluidly connected with each of the groove and the discharge channel.

17. The worktable for laser processing of claim 13, further comprising:
a third plate disposed on the second plate,
wherein the third plate comprises:
a third-first plate portion spaced apart from the second-first plate portion; and
a third-second plate portion in contact with the second-second plate portion, and
wherein a second empty space is defined between the third-first plate portion and the second-first plate portion.

18. A laser processing apparatus for laser processing an object, the laser processing apparatus comprising:
a first base part in which a first base part hole and a groove are defined;
a first plate disposed in the first base part hole; and
a second plate disposed on the first base part,
wherein the groove overlaps with a cutting line along which the laser processing apparatus cuts the object, and
wherein the second plate is spaced apart from the groove.

19. The laser processing apparatus of claim 18, wherein the second plate encloses at least a portion of the first plate in a plan view,
wherein the second plate comprises:
a second-first plate portion spaced apart from the first base part; and
a second-second plate portion connected to the second-first plate portion, and in contact with the first base part, and
wherein an empty space is defined between the second-first plate portion and the first base part.

20. The laser processing apparatus of claim 19, further comprising:
a suction unit, which inhales fumes generated from the laser processing,
wherein a discharge channel passing through the first base part is defined in the first base part,
wherein the fumes are sucked into the suction unit along each of a first path and a second path,
wherein the first path passes through the groove, and
wherein the second path passes through the empty space and the discharge channel.
